(19) United States
(12) Patent Application Publication
(10) Pub. No.: US 2024/0305974 A1
(43) Pub. Date: Sep. 12, 2024

(54) METHOD FOR MEASUREMENT GAP ENHANCEMENT, TERMINAL DEVICE, AND COMPUTER-READABLE STORAGE MEDIUM

(71) Applicant: GUANGDONG OPPO MOBILE TELECOMMUNICATIONS CORP., LTD., Dongguan (CN)

(72) Inventors: Rongyi HU, Dongguan (CN); Jinyu ZHANG, Dongguan (CN)

(21) Appl. No.: 18/666,183

(22) Filed: May 16, 2024

Related U.S. Application Data
(63) Continuation of application No. PCT/CN2021/133286, filed on Nov. 25, 2021.

(51) Int. Cl. H04W 8/22; H04L 5/00; H04W 24/10; H04W 72/0457; H04W 80/02

(52) U.S. Cl. CPC H04W 8/22; H04L 5/001; H04W 24/10; H04W 72/0457; H04W 80/02

(57) ABSTRACT

A method for measurement gap (MG) enhancement, a terminal device, and a computer-readable storage medium are provided in embodiments of the disclosure. The method includes the following. A terminal device determines a user equipment (UE) capability of the terminal device, where the UE capability indicates whether the terminal device supports a pre-configured MG (pre-MG) activation/deactivation (A/D) capability in a specific manner and/or a specific scenario.

### CROSS REFERENCE TO RELATED APPLICATION(S)

This application is a continuation of International Application No. PCT/CN2021/133286, filed Nov. 25, 2021, the entire disclosure of which is incorporated herein by reference.

### TECHNICAL FIELD

Embodiments of the disclosure relates to the technical field of mobile communications, and specifically to a method for measurement gap (MG) enhancement, a terminal device, and a computer-readable storage medium.

### BACKGROUND

In order for terminal devices to better realize mobility handover, a network can configure a specific time window for the terminal device, and thus the terminal device may perform measurement within the specific time window to perform mobility handover according to measurement results. The specific time window is referred to as a measurement gap (MG), which can also be abbreviated as a gap. One type of the MG is a pre-configured MG (pre-MG), where the pre-MG can be activated or deactivated. How to realize pre-MG activation/deactivation (A/D) needs to be improved and perfected.

### SUMMARY

The method for measurement gap (MG) enhancement provided in embodiments of the disclosure includes the following. A terminal device determines a user equipment (UE) capability of the terminal device, where the UE capability indicates whether the terminal device supports a pre-configured MG (pre-MG) activation/deactivation (A/D) capability in a specific manner and/or a specific scenario. The terminal device determines according to the UE capability whether to activate or deactivate a pre-MG.

A terminal device provided in embodiments of the disclosure includes a processor and a memory. The memory is configured to store computer programs, and the processor is configured to invoke and run the computer programs stored in the memory to: determine a UE capability of the terminal device, the UE capability indicating whether the terminal device supports a pre-MG A/D capability in a specific manner and/or a specific scenario; and determine according to the UE capability whether to activate or deactivate a pre-MG.

A non-transitory computer-readable storage medium provided in embodiments of the disclosure is configured to store computer programs. The computer programs enable a computer to: determine a UE capability of the terminal device, the UE capability indicating whether the terminal device supports a pre-MG A/D capability in a specific manner and/or a specific scenario; and determine according to the UE capability whether to activate or deactivate a pre-MG.

### BRIEF DESCRIPTION OF THE DRAWINGS

Accompanying drawings described herein are used to provide further understanding of the disclosure and form a part of the disclosure. The exemplary embodiments and illustrations of the disclosure are used to explain the disclosure and do not form improper limits to the disclosure. The accompanying drawings are as follows.

FIG. 1 is a schematic diagram illustrating an application scenario in embodiments of the disclosure.

FIG. 2 is a schematic flowchart illustrating a method for measurement gap (MG) enhancement provided in embodiments of the disclosure.

FIG. 3 is a schematic structural diagram of an apparatus for MG enhancement provided in embodiments of the disclosure.

FIG. 4 is a schematic structural diagram of a communication device provided in embodiments of the disclosure.

FIG. 5 is a schematic structural diagram of a chip in embodiments of the disclosure.

### DETAILED DESCRIPTION

The following will describe technical solutions of embodiments of the disclosure with reference to accompanying drawings. Apparently, embodiments described herein are some, rather than all of the disclosure. Based on the embodiments of the disclosure, all other embodiments obtained by those of ordinary skill in the art without creative effort shall fall within the scope of protection of the disclosure.

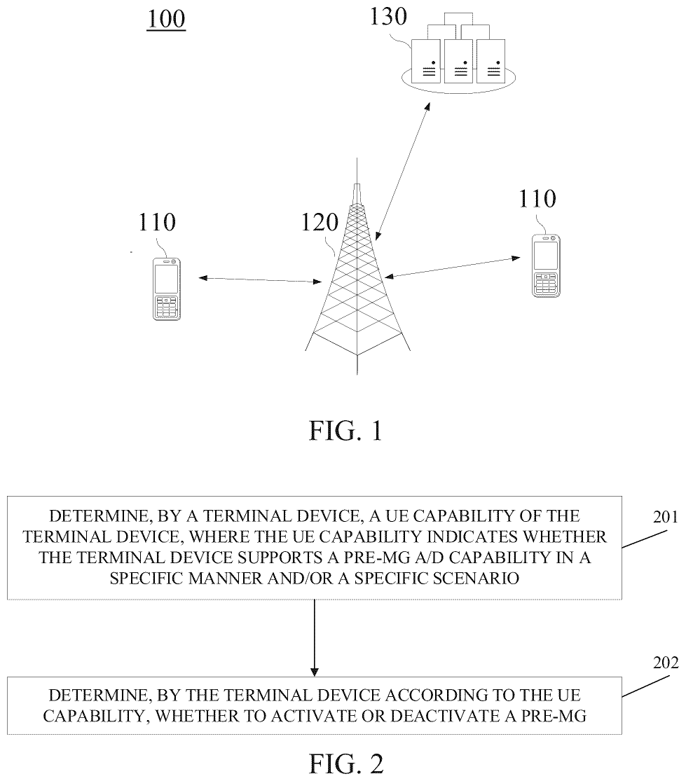

FIG. 1 is a schematic diagram illustrating an application scenario in embodiments of the disclosure.

As illustrated in FIG. 1, a communication system 100 may include a terminal device 110 and a network device 120. The network device 120 can communicate with the terminal device 110 via an air interface. The terminal device 110 and the network device 120 support a multi-service transmission.

It can be understood that, in embodiments of the disclosure, the communication system 100 is used simply for exemplarily illustration rather than limitation. That is, the technical solutions of embodiments of the disclosure are applicable to various communication systems. The various communication systems may include a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5th generation (5G) communication system (also referred to as a new radio (NR) communication system), or a future communication system.

In the communication system 100 as illustrated in FIG. 1, the network device 120 may be an access network device that communicates with the terminal device 110. The access network device can provide a communication coverage for a specific geographic area and communicate with terminal devices 110 (e.g., a user equipment (UE)) in the coverage area.

The network device 120 may be an evolved NodeB (eNB or eNodeB) in the LTE system, a next generation radio access network (NG RAN) device, a gNB in the NR system, or a radio controller in a cloud radio access network (CRAN). Alternatively, the network device 120 may also be a relay station, an access point (AP), an in-vehicle device, a wearable device, a hub, a switch, a bridge, a router, or a network device in a future evolved public land mobile network (PLMN).

The terminal device 110 may be any terminal device, which includes, but is not limited to, a terminal device that connects to the network device 120 or other terminal devices in a wired or wireless manner.

For example, the terminal device 110 may be referred to as an access terminal, a UE, a subscriber unit, a subscriber station, a mobile station, a remote station, a remote terminal, a mobile device, a user terminal, a terminal, a wireless communication device, a user agent, a user device, etc. The access terminal may be a cellular radio telephone, a cordless telephone, a session initiation protocol (SIP) telephone, an IoT device, a satellite handheld terminal, a wireless local loop (WLL) station, a personal digital assistant (PDA), a handheld device with wireless communication functions, a computing device, other processing devices coupled with a wireless modem, an in-vehicle device, a wearable device, or a terminal device in a 5G network, a terminal device in a future evolved network, etc.

The terminal device 110 can be configured for device to device (D2D) communication.

The wireless communication system 100 may further include a core network device 130 that communicates with a base station. The core network device 130 may be a 5G core (5GC) device, an access and mobility management function (AMF) device, an authentication server function (AUSF) device, a user plane function (UPF) device, or a session management function (SMF) device. Optionally, the core network device 130 may also be an evolved packet core (EPC) device in the LTE network such as a session management function+core packet gateway (SMF+PGW-C) device. It can be understood that, the SMF+PGW-C device can implement functions of both SMF and PGW-C. With the evolution of the network, the core network device may also have other names, or a new network entity can be formed by dividing functions of the core network, which will not be limited herein.

Various functional units in the communication system 100 may establish a connection with one another via a next generation (NG) interface for communication.

For example, the terminal device establishes an air interface connection with the access network device via an NR interface to transmit user-plane data and control-plane signaling. The terminal device can establish a control-plane signaling connection with the AMF device via NG interface 1 (N1 for short). The access network device, e.g., a next generation wireless access base station (gNB), can establish a user-plane data connection with the UPF device via NG interface 3 (N3 for short). The access network device can establish a control-plane signaling connection with the AMF device via NG interface 2 (N2 for short). The UPF device can establish a control-plane signaling connection with the SMF device via NG interface 4 (N4 for short). The UPF device can exchange user-plane data with a data network via NG interface 6 (N6 for short). The AMF device can establish a control-plane signaling connection with the SMF device via NG interface 11 (N11 for short). The SMF device can establish a control-plane signaling connection with a policy control function (PCF) device via NG interface 7 (N7 for short).

FIG. 1 exemplarily illustrates a base station, a core network device, and two terminal devices. Optionally, the wireless communication system 100 may include multiple base stations and the other number of terminal devices that may be included in a coverage range of each of the multiple base stations, which will not be limited in embodiments of the disclosure.

It may be noted that FIG. 1 only illustrates a system to which the disclosure is applicable by way of example, and certainly, the method illustrated in embodiments of the disclosure may also be applicable to other systems. In addition, the terms “system” and “network” in this disclosure are often used interchangeably. The term “and/or” in this disclosure is simply an illustration of an association relationship of associated objects, indicating that three relationships can exist, for example, A and/or B, which can indicate the existence of A alone, A and B together, and B alone. In addition, the character “/” in this disclosure generally indicates that associated objects are in an “or” relationship. It may also be understood that the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation. It may also be understood that the “correspondence” mentioned in embodiments of the disclosure may represent a direct correspondence or indirect correspondence between the two, may also represent an associated relation between the two, or may further represent a relation of indicating and being indicated, a relation of configuring and being configured, or other relations. It may also be understood that, “predefinition” or “predefined rule” mentioned in embodiments of the disclosure may be implemented by pre-storing corresponding codes, tables, or other modes indicating relevant information in a device (for example, including a terminal device and a network device), and specific embodiments are not limited in the disclosure. For example, predefinition may refer to definition in a protocol. It may also be understood that, in embodiments of the disclosure, “protocol” may refer to a standard protocol in the field of communication, and may include, for example, an LTE protocol, an NR protocol, and a related protocol applicable to a future communication system, which is not limited in the disclosure.

In order to facilitate understanding of the technical solutions of embodiments of the disclosure, the following describes the related technologies of embodiments of the disclosure. The related technologies below as an optional solution may be arbitrarily combined with the technical solutions of embodiments of the disclosure, and any combination thereof may belong to the scope of protection of embodiments of the disclosure.

### Measurement Gap (MG)

In order for a terminal device to better realize mobility handover, a network may configure the terminal device to measure within a specific time window a reference signal (RS) for a target neighboring cell. The target neighboring cell may be an intra-frequency neighboring cell, an inter-frequency neighboring cell, or an inter-radio access technology (RAT) neighboring cell. As an example, the RS may be measured in reference signal received power (RSRP), reference signal received quality (RSRQ), or a signal to interference plus noise ratio (SINR). The specific time window is referred to as an MG.

The study of the NR system mainly considers two frequency ranges (FRs), i.e., FR1 and FR2, where a range of frequencies corresponding to FRI and a range of frequencies corresponding to FR2 are illustrated in Table 1. FRI is also known as 6 GHz sub-band, and FR2 is also known as millimeter-wave band. It may be noted that the range of frequencies corresponding to FRI and the range of frequencies corresponding to FR2 are not limited to ranges of frequencies illustrated in Table 1 and can be adjusted.

TABLE 1

| FR | range of frequency |
|---|---|
| FR1 | 450 MHz-6 GHz |
| FR2 | 24.25 GHz-52.6 GHz |

According to whether the terminal device supports a capability of independent operation in FRI and FR2, there are two types of MGs, one is a per-UE MG (per UE gap), and the other is a per-FR MG (per FR gap). Furthermore, the per FR gap is classified into a per FR1 gap and a per FR2 gap. The per UE gap is also referred to as gapUE, the per FRI gap is also referred to as gapFR1, and the per FR2 gap is also referred to as gapFR2. Moreover, a capability indication indicating whether the terminal device supports a capability of independent operation in FRI and FR2 is introduced for the UE. The capability indication is referred to as independentGapConfig and is used by the network to determine whether a per-FR MG, e.g., a per FR1 gap or a per FR2 gap, can be configured. Specifically, when the capability indication indicates that the terminal device supports independent operation in FRI and FR2, the network can configure a per-FR MG. When the capability indication indicates that the terminal device does not support independent operation in FRI and FR2, the network cannot configure a per-FR MG and can configure only a per-UE MG (i.e., a per UE gap).

The following describes a per FR1 gap, a per FR2 gap, and a per UE gap.

The per FR1 gap (i.e., gapFR1): an MG of the type of per FR1 gap is only applicable to FR1 measurement. It is not supported that both a per FR1 gap and a per UE gap are configured.

In an evolved universal terrestrial radio access (E-UTRA) and NR dual connectivity (DC) (EN-DC) mode, a master node (MN) is of an LTE standard and a secondary node (SN) is of an NR standard, and only the MN can configure a per FR1 gap.

The per FR2 gap (i.e., gapFR2): an MG of the type of per FR2 gap is only applicable to FR2 measurement. It is not supported that both a per FR2 gap and a per UE gap are configured. It is supported that both a per FR2 gap and a per FR1 gap are configured.

When the terminal device supports the capability of independent operation in FR1 and FR2 (i.e., an independent gap capability), the terminal device can perform independent measurement for FR1 and FR2, and the terminal device can be configured with an MG of the type of per FR gap, e.g., an MG of the type of per FR1 gap and an MG of the type of per FR2 gap.

The per UE gap (gapUE): an MG of the type of per UE gap is applicable to measurement for all FRs (including FR1 and FR2).

In the EN-DC mode, the MN is of an LTE standard, the SN is of an NR standard, and only the MN can configure a per UE gap. If the per UE gap is configured, a per FR gap (e.g., a per FR1 gap and a per FR2 gap) cannot be configured any more.

In an MG of the type of per UE gap, the terminal device is not allowed to transmit any data and is not expected to adjust a receiver for a primary carrier and a secondary carrier.

### Measurement Configuration

The network configures a measurement configuration (i.e., MeasConfig) via radio resource control (RRC) dedicated signaling. As illustrated in Table 2, MeasConfig includes an MG configuration and a measurement object (MO) configuration, where the MG configuration is measGapConfig and the MO configuration is measObjectToAddModList.

TABLE 2

| | | | |
|---|---|---|---|
| MeasConfig ::= | SEQUENCE { | | |
| measObjectToAddModList | MeasObjToAddModList | OPTIONAL, | -- Need N |
| ...... | | | |
| measGapConfig | MeasGapConfig | OPTIONAL, | -- Need M |
| } | | | |

Furthermore, referring to Table 3, a content of measGapConfig in Table 2 is illustrated. Configuration information for an MG includes: an MG offset (i.e., gapOffset), an MG period (i.e., MG repetition period (MGRP)), and an MG length (i.e., MGL), where gapOffset is used to determine a starting point of the MG.

TABLE 3

| | | |
|---|---|---|
| MeasGapConfig ::= | SEQUENCE { | |
| gapFR2 | SetupRelease { GapConfig } | OPTIONAL, |
| -- Need M | | |
| gapFR1 | SetupRelease { GapConfig } | OPTIONAL, |
| -- Need M | | |
| gapUE | SetupRelease { GapConfig } | OPTIONAL |
| -- Need M | | |
| } | | |
| GapConfig ::= | SEQUENCE { | |
| gapOffset | INTEGER (0..159), | |

| | |
|---|---|
| mgl | ENUMERATED {ms1dot5, ms3, ms3dot5, ms4, msdot5, ms6}, |
| mgrp | ENUMERATED {ms20, ms40, ms80, ms160}, |
| mgta | ENUMERATED {ms0, ms0dot25, ms0dot5}, |

An MG may be of a type of per UE gap, a type of per FR1 gap, or a type of per FR2 gap. Referring to Table 4, 24 types of patterns for the MG (gap patterns for short) are supported, and different gap patterns correspond to different MGRPs and/or MGLs. Some gap patterns are used for FR1 measurement and correspond to a per FR1 gap. Some gap patterns are used for FR2 measurement and correspond to a per FR2 gap.

TABLE 4

| gap pattern | MGL | MGRP |
|---|---|---|
| identifier (ID) | (ms) | (ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |

In addition to the 24 types of gap patterns illustrated in Table 4, other gap patterns may also be introduced, for example, a gap pattern for positioning reference signal (PRS) measurement may be introduced. Referring to Table 5, a gap pattern with a gap pattern ID 24 and a gap pattern with a gap pattern ID 25 are given, where the two gap patterns are used for PRS measurement.

TABLE 5

| gap pattern ID | MGL (ms) | MGRP (ms) |
|---|---|---|
| 24 | 10 | 80 |
| 25 | 20 | 160 |

Furthermore, referring to Table 6, a content of measObjectToAddModList in Table 2 is illustrated, where configuration information for an MO may include a synchronization signal/physical broadcast channel block (SS/PBCH block, SSB) measurement timing configuration (SMTC) associated with the MO. The SMTC can be configured to support a period of {5, 10, 20, 40, 80, 160} ms and a window length of {1, 2, 3, 4, 5} ms. A time offset of the SMTC is strongly correlated with the period and takes a value from {0, . . . , period−1,}. Since a carrier frequency is no longer included in the MO, the SMTC can be configured independently per MO instead of per frequency.

TABLE 6

| MeasObjectToAddModList ::= | SEQUENCE (SIZE (1..maxNrofObjectId)) OF | |
|---|---|---|
| MeasObjectToAddMod | | |
| MeasObjectToAddMod ::= | SEQUENCE { | |
| measObjectId | MeasObjectId, | |
| measObject | CHOICE { | |
| measObjectNR | MeasObjectNR, | |
| ..., | | |
| measObjectEUTRA | MeasObjectEUTRA | |
| } | | |
| } | | |
| MeasObjectNR ::= | SEQUENCE { | |
| ssbFrequency | ARFCN-ValueNR | OPTIONAL, -- Cond |
| SSBorAssociatedSSB | | |
| ssbSubcarrierSpacing | SubcarrierSpacing | OPTIONAL, -- Cond |
| SSBorAssociatedSSB | | |
| smtc1 | SSB-MTC | OPTIONAL, -- Cond |
| SSBorAssociatedSSB | | |
| smtc2 | SSB-MTC2 | OPTIONAL, -- Cond |
| IntraFreqConnected | | |
| refFreqCSI-RS | ARFCN-ValueNR | OPTIONAL, -- Cond CSI-RS |
| referenceSignalConfig | ReferenceSignalConfig, | |
| absThreshSS-BlocksConsolidation | ThresholdNR | OPTIONAL, -- Need R |
| absThreshCSI-RS-Consolidation | ThresholdNR | OPTIONAL, -- Need R |

| | |
|---|---|
| nrofSS-BlockToAverage | INTEGER (2..maxNrofSS-BlocksToAverage) OPTIONAL, |
| -- Need R | |

nrofCSI-RS-ResourceToAverage INTEGER (2..maxNrofCSI-RS-ResourcesToAverage)

| OPTIONAL, -- Need R | | |
|---|---|---|
| quantityConfigIndex | INTEGER (1..maxNrofQuantityConfig), | |
| offsetMO | Q-OffsetRangeList, | |
| cellsToRemoveList | PCI-List | OPTIONAL, -- Need N |
| cellsToAddModList | CellsToAddModList | OPTIONAL, -- Need N |
| blackCellsToRemoveList | PCI-RangeIndexList | OPTIONAL, -- Need N |
| blackCellsToAddModList | SEQUENCE (SIZE (1..maxNrofPCI-Ranges)) OF PCI- | |
| RangeElement OPTIONAL, | -- Need N | |
| whiteCellsToRemoveList | PCI-RangeIndexList | OPTIONAL, -- Need N |
| whiteCellsToAddModList | SEQUENCE (SIZE (1..maxNrofPCI-Ranges)) OF PCI- | |
| RangeElement OPTIONAL | -- Need N | |
| } | | |

Referring to Table 7, for intra-frequency measurement in an RRC connected state, 2 SMTCs (e.g., SMTC and SMTC2) can be configured for 1 frequency layer, where the 2 SMTCs have the same time offset but different periods. For inter-frequency measurement in the RRC connected state, only 1 SMTC is configured. As can be seen, SMTC2 is only supported to be configured for intra-frequency measurement. It may be noted that a period of SMTC2 is shorter than that of SMTC, and a time offset of SMTC can be used as a time offset of SMTC2.

TABLE 7

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0.159) }, |
| duration | ENUMERATED { sf1, sf2, sf3, sf4, sf5 } |
| } | |
| SSB-MTC2 ::= | SEQUENCE { |

pci-List SEQUENCE (SIZE (1..maxNrofPCIsPerSMTC)) OF PhysCellId

| | |
|---|---|
| OPTIONAL, -- Need M | |
| periodicity | ENUMERATED {sf5, sf10, sf20, sf40, sf80, spare3, spare2, |
| spare1} | |
| } | |

### Pre-Configured MG (Pre-MG)

The pre-MG can be activated or deactivated. In specific implementation, the network device can activate or deactivate the pre-MG via signaling (e.g., RRC signaling or a medium access control (MAC) control element (CE)), or the terminal device can activate or deactivate the pre-MG automatically according to a predefined rule. The predefined rule may be the following.

Rule 1 is to activate or deactivate the pre-MG in case of MO change. MO change is reflected by at least one of: adding an MO, removing an MO, adding a primary secondary cell (PSCell), releasing a PSCell, changing a PSCell, activating a secondary cell (SCell), or deactivating an SCell.

Rule 2 is to activate or deactivate the pre-MG in case of band width part (BWP) change. The pre-MG is activated if a band width (BW) of an SSB configured for measurement is not fully within a BW of an active BWP. The pre-MG is deactivated if the BW of the SSB configured for measurement is fully within the BW of the active BWP.

The pre-MG is activated or deactivated according to a principle that 1) the pre-MG is activated if a pre-MG is not required by any of configured measurements; and 2) the pre-MG is activated if a pre-MG is required by one or more of the configured measurements.

### BWP

The terminal device can be configured with at most four uplink BWPs and at most four downlink BWPs via RRC dedicated signaling, but only one uplink BWP and one downlink BWP can be activated at the same time. The RRC-specific signaling may indicate a first BWP to be activated in the configured BWPs. It is possible to switch between different BWPs according to downlink control information (DCI) when the terminal is in the connected state. When a carrier in the deactivation status enters the activation status, a first BWP to be activated is the first BWP to be activated in the BWPs configured via the RRC dedicated signaling.

For the pre-MG, since the pre-MG can be activated or deactivated, there is a need for a well-developed mechanism to realize pre-MG activation/deactivation (A/D). To this end, technical solutions in embodiments of the disclosure are proposed as follows.

In order to facilitate understanding of the technical solutions of embodiments of the disclosure, the following describes in details the related technologies of the disclosure through specific embodiments. The related technologies above as an optional solution may be arbitrarily combined with the technical solutions of embodiments of the disclosure, and any combination thereof may belong to the scope of protection of embodiments of the disclosure. The embodiments of the disclosure include at least part of the following.

In the technical solutions in embodiments of the disclosure, a method for MG enhancement in a carrier aggregation (CA) or DC network architecture is provided to flexibly support measurement performed by a terminal device.

It may be noted that “A/D” as described in embodiments of the disclosure may include activation and/or deactivation.

FIG. 2 is a schematic flowchart illustrating a method for MG enhancement provided in embodiments of the disclosure. As illustrated in FIG. 2, the method for MG enhancement includes the following.

201, the terminal device determines a UE capability of the terminal device, where the UE capability indicates whether the terminal device supports a pre-MG A/D capability in a specific manner and/or a specific scenario.

In embodiments of the disclosure, the terminal device may determine the UE capability of the terminal device via pre-configured information, where the UE capability may be pre-configured in the terminal device. The UE capability indicates whether the terminal device supports the pre-MG A/D capability in the specific manner and/or the specific scenario.

### Specific Manner

In some optional embodiments, the specific manner includes at least one of: a first manner, a second manner, or a third manner. The first manner is an RRC signaling-based pre-MG A/D manner. The second manner is an MAC CE-based pre-MG A/D manner. The third manner is a rule-based autonomous pre-MG A/D manner.

It may be noted that the first manner, the second manner, and the third manner in the above solution may be understood as three pre-MG A/D mechanisms. For example, the first manner may be understood as an RRC based A/D mechanism, the second manner may be understood as an MAC CE based A/D mechanism, and the third manner may be understood as a rule based UE autonomous A/D mechanism.

In some optional embodiments, for the first manner, the RRC signaling carries a BWP configuration. The BWP configuration includes first indication information, and the first indication information indicates an A/D status of a pre-MG associated with a BWP. As an example, the BWP configuration includes 1-bit indication information, a value of 1 bit being 1 indicates that the pre-MG associated with the BWP is in an activation status (i.e., on), and the value of 1 bit being 0 value indicates that the pre-MG associated with the BWP is in a deactivation status (i.e., off).

In some optional embodiments, for the first manner, the RRC signaling carries a separated RRC configuration that is not used in an existing configuration. The RRC configuration indicates an A/D status of each of at least one pre-MG.

As an example, in specific implementation, the RRC configuration includes a first bitmap, where each bit in the first bitmap corresponds to a pre-MG, and a value of a bit indicates an A/D status of a pre-MG corresponding to the bit.

In the above solution, a status of a pre-MG for PRS measurement is not changed with BWP switching, a value of a bit corresponding to the pre-MG for PRS measurement in the first bitmap is a first value, and the first value indicates that the pre-MG for PRS measurement is in an activation status. A status of a pre-MG for SSB measurement can be changed with BWP switching.

In the above solution, for channel state information-reference signal (CSI-RS)-based layer 3 (L3) measurement or PRS-based measurement, a default status of the pre-MG is active; and for SSB-based L3 measurement, the default status of the pre-MG is configurable (i.e., it is not fixed). Specifically, the default status of the pre-MG can be configured in any one of the first manner, the second manner, and the third manner mentioned above.

In some optional embodiments, for the first manner, the RRC signaling carries both a BWP configuration and a separated RRC configuration. The BWP configuration includes first indication information, and the first indication information indicates an A/D status of a pre-MG associated with a BWP. The RRC configuration indicates an A/D status of each of at least one pre-MG. The RRC configuration herein can refer to the preceding embodiment. In this case, the A/D status indicated by the RRC configuration has a priority higher than the A/D status indicated by the BWP configuration; or the A/D status indicated by the RRC configuration overrides the A/D status indicated by the BWP configuration.

In some optional embodiments, for the first manner, the RRC signaling carries second indication information, where the second indication information indicates at least one set of information. Each of the at least one set of information contains a BWP ID and a flag corresponding to the BWP ID, and a value of the flag includes at least one of: a first value, a second value, or a third value. The value of the flag being the first value indicates that an MG configuration associated with a BWP indicated by the BWP ID is in a deactivation status. The value of the flag being the second value indicates that the MG configuration associated with the BWP indicated by the BWP ID is in an activation status, or indicates that the BWP indicated by the BWP ID is in the deactivation status and the MG configuration associated with the BWP is in the activation status. The value of the flag being the third value indicates that the BWP indicated by the BWP ID is in the activation status and the MG configuration associated with the BWP is in the activation status.

In some optional embodiments, for the third manner, the rule includes at least one of a first rule or a second rule. The first rule is to automatically activate or deactivate the pre-MG according to a trigger event, where the trigger event includes at least one of: BWP switching, adding an MO, removing an MO, adding a PSCell, releasing a PSCell, changing a PSCell, adding an SCell, releasing an SCell, changing an SCell, activating an SCell, deactivate an SCell, or a dedicated measurement requirement. The second rule is to deactivate the pre-MG if an MG is not required by any of configured MOs; or activate the pre-MG if an MG is required by any one of the configured MOs.

Furthermore, the trigger event is BWP switching, and the first rule specifically includes activating the pre-MG if a BW of an RS for a configured MO is not fully within an active BWP; or deactivating the pre-MG if the BW of the RS for the configured MO is fully within the active BWP.

The UE capability in three manners are defined through the above solution. The UE capability corresponding to the first manner may also be referred to as a first UE capability, the UE capability corresponding to the second manner may also be referred to as a second UE capability, and the UE capability corresponding to the third manner may also be referred to as a third UE capability. The terminal device may have any one or more of the above three UE capabilities.

### Specific Scenario

In some optional embodiments, the specific scenario includes at least one of: a first scenario, a second scenario, or a third scenario. The first scenario is a scenario in which a single active BWP is on a single component carrier (CC). The second scenario is a scenario in which BWP switching is performed on CCs which are aggregated. The third scenario is a scenario in which multiple active BWPs are on multiple CCs.

In the above solution, the first scenario can be described as a single active BWP on a single CC.

In the above solution, the second scenario can be described as a CA case with single BWP switching.

In the above solution, the third scenario can be described as multiple active BWPs on multiple CCs. Distribution of the multiple active BWPs on the multiple CCs may be that a single active BWP is on a single CC, or multiple active BWPs are on a single CC.

In some optional embodiments, the specific manner is a BWP switching-based autonomous pre-MG A/D manner and is applied in at least one of the first scenario, the second scenario, or the third scenario.

The UE capability in three scenarios are defined through the above solution. The UE capability in the first scenario may also be referred to as a fourth UE capability, the UE capability in the second scenario may also be referred to as a fifth UE capability, and the UE capability in the third scenario may also be referred to as a sixth UE capability. The terminal device may have any one or more of the above three UE capabilities.

202, the terminal device determines according to the UE capability whether to activate or deactivate a pre-MG.

In embodiments of the disclosure, the terminal device determining according to the UE capability whether to activate or deactivate the pre-MG may be implemented in the following solutions.

### Solution 1

In the case that the UE capability indicates that the terminal device supports the third manner and does not support the first manner, the terminal device determines to activate the pre-MG as long as a pre-MG status of an active BWP in at least one of multiple CCs is active; and the terminal device determines to deactivate the pre-MG only if pre-MG statuses of active BWPs in all the multiple CCs are inactive.

In some optional embodiments, in the case that the pre-MG is a pre-UE gap, the terminal device determines to activate the pre-MG in response to a pre-MG status of an active BWP in at least one of multiple CCs which are aggregated being active; and the terminal device determines to deactivate the pre-MG in response to pre-MG statuses of active BWPs in all the multiple CCs which are aggregated being inactive.

In some optional embodiments, in the case that the pre-MG is a pre-FR gap, the terminal device determines to activate the pre-MG if a pre-MG status of an active BWP in at least one of multiple CCs in an FR same as an FR where the pre-MG is located is active; and the terminal device determines to deactivate the pre-MG if pre-MG statuses of active BWPs in all the multiple CCs in the FR same as the FR where the pre-MG is located are inactive.

In some optional embodiments, in the case that the pre-MG is a CC group gap, the terminal device determines to activate the pre-MG if a pre-MG status of an active BWP in at least one of multiple CCs in a CC group same as a CC group where the pre-MG is located is active; and the terminal device determines to deactivate the pre-MG if pre-MG statuses of active BWPs in all the multiple CCs in the CC group same as the CC group where the pre-MG is located is inactive. The terminal device supports a CC group gap capability in the case that the pre-MG is a CC group gap, where the CC group gap capability is a separate gap measurement capability related to a CC group. As an example, the capability may be referred to as per-BC indication of per-FR measurement gap UE capabilities, where BC represents band combination, which may also be referred to as a CC group or a band group.

### Solution 2

In the case that the UE capability indicates that the terminal device supports the first manner or supports the first manner and the third manner, for the first manner, the RRC signaling carries a BWP configuration, where the BWP configuration includes first indication information, and the first indication information indicates an A/D status of a pre-MG associated with a BWP.

In the case that the pre-MG is a pre-UE gap, the terminal device determines to activate the pre-MG if a pre-MG status of an active BWP in at least one of multiple CCs which are aggregated is active; and the terminal device determines to deactivate the pre-MG if pre-MG statuses of active BWPs in all the multiple CCs which are aggregated are inactive.

In the case that the pre-MG is a pre-FR gap, the terminal device determines to activate the pre-MG if a pre-MG status of an active BWP in at least one of multiple CCs in an FR same as an FR where the pre-MG is located is active; and the terminal device determines to deactivate the pre-MG if pre-MG statuses of active BWPs in all the multiple CCs in the FR same as the FR where the pre-MG is located are inactive.

### Solution 3

In the case that the UE capability indicates that the terminal device supports the first manner or supports the first manner and the third manner, for the first manner, the RRC signaling carries a BWP configuration and an RRC configuration. The BWP configuration includes first indication information, and the first indication information indicates an A/D status of a pre-MG associated with a BWP. The RRC configuration indicates an A/D status of each of at least one pre-MG.

Since the A/D status indicated by the RRC configuration has a priority higher than the A/D status indicated by the BWP configuration; or the A/D status indicated by the RRC configuration overrides the A/D status indicated by the BWP configuration, Option 1) and Option 2) are performed.

Option 1), in the case that the UE capability indicates that the terminal device supports the first manner or supports the first manner and the third manner, the RRC configuration indicates that a status of a first pre-MG is active, and the first pre-MG is a pre-UE gap, the terminal device determines to activate the first pre-MG if a pre-MG status of an active BWP in at least one of multiple CCs which are aggregated is active; and the terminal device determines to deactivate the first pre-MG if pre-MG statuses of active BWPs in all the multiple CCs which are aggregated are inactive. In the case that the UE capability indicates that the terminal device supports the first manner or supports the first manner and the third manner, the RRC configuration indicates that a status of a first pre-MG is active, and the first pre-MG is a pre-FR gap, the terminal device determines to activate the first pre-MG if a pre-MG status of an active BWP in at least one of multiple CCs in an FR same as an FR where the first pre-MG is located is active; and the terminal device determines to deactivate the first pre-MG if pre-MG statuses of active BWPs in all the multiple CCs in the FR same as the FR where the first pre-MG is located are inactive.

Option 2), the terminal device determines to deactivate a second pre-MG in the case that the RRC configuration indicates that a status of the second pre-MG is inactive.

### Solution 4

In the case that the UE capability indicates that the terminal device supports the first manner or supports the first manner and the third manner, for the first manner, the RRC signaling carries second indication information. The second indication information indicates at least one set of information, each of the at least one set of information contains a BWP ID and a flag corresponding to the BWP ID, and a value of the flag includes at least one of: a first value, a second value, or a third value. The value of the flag being the first value indicates that an MG configuration associated with a BWP indicated by the BWP ID is in a deactivation status. The value of the flag being the second value indicates that the MG configuration associated with the BWP indicated by the BWP ID is in an activation status, or indicates that the BWP indicated by the BWP ID is in the deactivation status and the MG configuration associated with the BWP is in the activation status. The value of the flag being the third value indicates that the BWP indicated by the BWP ID is in the activation status and the MG configuration associated with the BWP is in the activation status.

The terminal device determines to activate the pre-MG if a value of at least one flag in the at least one set of information is the second value or the third value; and the terminal device determines to deactivate the pre-MG if values of all flags in the at least one set of information each are the first value.

In the above solution, as an example, the first value may be 0 (i.e., 00), the second value may be 1 (i.e., 01), and the third value may be 2 (i.e., 10).

### Solution 5

The terminal device determines that a pre-MG status of a BWP on an SCell is inactive if the SCell is in a deactivation status.

In the technical solutions of embodiments of the disclosure, the solution for MG enhancement in a CA or DC network is provided, thereby realizing pre-MG A/D in different manners and/or scenarios, realizing reasonable on/off of the pre-MG, and ensuring that the terminal and the network side can reach a unified understanding of the status of the pre-MG, and thus avoiding excessive data communication interruptions while measurement is ensured.

Preferable embodiments of the disclosure have been described in detail above with reference to the accompanying drawings. However, the disclosure is not limited to the details described in the foregoing embodiments. Within the scope of the technical concept of the disclosure, various simple modifications can be made to the technical solutions of the disclosure, and these simple modifications all falls within the protection scope of the disclosure. For example, various technical features described in the foregoing embodiments may be combined in any suitable manner without contradiction, and in order to avoid unnecessary redundancy, various possible combinations are not further described in the disclosure. For another example, various embodiments of the disclosure may also be combined in any manner, and if the combinations do not depart from the idea of the disclosure, they may also be considered as contents disclosed in the disclosure. For yet another example, various embodiments described in the disclosure and/or technical features of the various embodiments may be combined with the related art arbitrarily without conflict, and technical solutions thus obtained shall also fall within the protection scope of the disclosure.

It may also be understood that, in various method embodiments of the disclosure, the magnitude of a sequence number of each of the foregoing processes does not mean an execution order, and an execution order of each process may be determined according to a function and an internal logic of the process, which shall not constitute any limitation to an implementation process of embodiments of the disclosure. In addition, in embodiments of the disclosure, the terms “downlink”, “uplink”, and “sidelink” indicate a transmission direction of a signal or data, where “downlink” indicates that a transmission direction of a signal or data is a first direction from a station to a UE in a cell, “uplink” indicates that a transmission direction of a signal or data is a second direction from a UE in a cell to a station, and “sidelink” indicates that a transmission direction of a signal or data is a third direction from UE1 in a cell to UE2 in a cell. For example, a “downlink signal” indicates that a transmission direction of the signal is the first direction. Furthermore, in embodiments of the disclosure, the term “and/or” herein only describes an association relationship between associated objects, which means that there can be three relationships. Specifically, A and/or B can mean A alone, both A and B exist, and B alone. Besides, the character “/” herein generally indicates that the associated objects are in an “or” relationship.

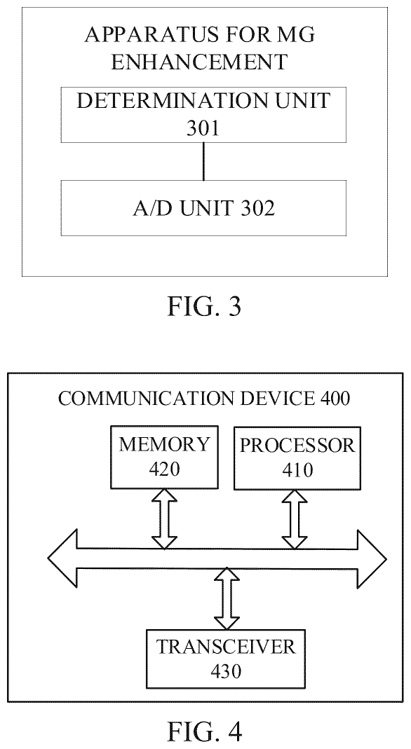

FIG. 3 is a schematic structural diagram of an apparatus for MG enhancement provided in embodiments of the disclosure. The apparatus for MG enhancement is applied for a terminal device. As illustrated in FIG. 3, the apparatus for MG enhancement includes a determination unit 301 and an A/D unit 302. The determination unit 301 is configured to determine a UE capability of the terminal device, where the UE capability indicates whether the terminal device supports a pre-MG A/D capability in a specific manner and/or a specific scenario. The A/D unit 302 is configured to determine according to the UE capability whether to activate or deactivate a pre-MG.

In some optional embodiments, the specific manner includes at least one of: a first manner, a second manner, or a third manner. The first manner is an RRC signaling-based pre-MG A/D manner. The second manner is an MAC CE-based pre-MG A/D manner. The third manner is a rule-based autonomous pre-MG A/D manner.

In some optional embodiments, the A/D unit 302 is configured to perform the following in the case that the UE capability indicates that the terminal device supports the third manner and does not support the first manner. The A/D unit 302 is configured to determine to activate the pre-MG if a pre-MG status of an active BWP in at least one of multiple CCs is active. The A/D unit 302 is configured to determine to deactivate the pre-MG if pre-MG statuses of active BWPs in all the multiple CCs are inactive.

In some optional embodiments, the A/D unit 302 is configured to determine to activate the pre-MG if a pre-MG status of an active BWP in at least one of multiple CCs which are aggregated is active, in the case that the pre-MG is a pre-UE gap; and determine to deactivate the pre-MG if pre-MG statuses of active BWPs in all the multiple CCs which are aggregated are inactive, in the case that the pre-MG is the pre-UE gap. The A/D unit 302 is configured to determine to activate the pre-MG if a pre-MG status of an active BWP in at least one of multiple CCs in an FR same as an FR where the pre-MG is located is active, in the case that the pre-MG is a pre-FR gap; and determine to deactivate the pre-MG if pre-MG statuses of active BWPs in all the multiple CCs in the FR same as the FR where the pre-MG is located are inactive, in the case that the pre-MG is the pre-FR gap.

In some optional embodiments, the A/D unit 302 is configured to determine to activate the pre-MG if a pre-MG status of an active BWP in at least one of multiple CCs in a CC group same as a CC group where the pre-MG is located is active, in the case that the pre-MG is a CC group gap; and determine to deactivate the pre-MG if pre-MG statuses of active BWPs in all the multiple CCs in the CC group same as the CC group where the pre-MG is located is inactive, in the case that the pre-MG is the CC group gap.

In some optional embodiments, the terminal device supports a CC group gap capability in the case that the pre-MG is a CC group gap, where the CC group gap capability is a separate gap measurement capability related to a CC group.

In some optional embodiments, the RRC signaling carries a BWP configuration, where the BWP configuration includes first indication information, and the first indication information indicates an A/D status of a pre-MG associated with a BWP.

In some optional embodiments, the A/D unit 302 is configured to perform the following in the case that the UE capability indicates that the terminal device supports the first manner or supports the first manner and the third manner. The A/D unit 302 is configured to determine to activate the pre-MG if a pre-MG status of an active BWP in at least one of multiple CCs which are aggregated is active, in the case that the pre-MG is a pre-UE gap; and determine to deactivate the pre-MG if pre-MG statuses of active BWPs in all the multiple CCs which are aggregated are inactive, in the case that the pre-MG is the pre-UE gap. The A/D unit 302 is configured to determine to activate the pre-MG if a pre-MG status of an active BWP in at least one of multiple CCs in an FR same as an FR where the pre-MG is located is active, in the case that the pre-MG is a pre-FR gap; and determine to deactivate the pre-MG if pre-MG statuses of active BWPs in all the multiple CCs in the FR same as the FR where the pre-MG is located are inactive, in the case that the pre-MG is the pre-FR gap.

In some optional embodiments, the RRC signaling carries a BWP configuration and an RRC configuration. The BWP configuration includes first indication information, and the first indication information indicates an A/D status of a pre-MG associated with a BWP. The RRC configuration indicates an A/D status of each of at least one pre-MG.

In some optional embodiments, the RRC configuration contains a first bitmap, where each bit in the first bitmap corresponds to a pre-MG, and a value of a bit indicates an A/D status of a pre-MG corresponding to the bit.

In some optional embodiments, a status of a pre-MG for PRS measurement is not changed with BWP switching, a value of a bit corresponding to the pre-MG for PRS measurement in the first bitmap is a first value, and the first value indicates that the pre-MG for PRS measurement is in an activation status. A status of a pre-MG for SSB measurement can be changed with BWP switching.

In some optional embodiments, the A/D status indicated by the RRC configuration has a priority higher than the A/D status indicated by the BWP configuration, or the A/D status indicated by the RRC configuration overrides the A/D status indicated by the BWP configuration.

In some optional embodiments, the A/D unit 302 is configured to perform the following, in the case that the UE capability indicates that the terminal device supports the first manner or supports the first manner and the third manner and the RRC configuration indicates that a status of a first pre-MG is active. The A/D unit 302 is configured to determine to activate the first pre-MG if a pre-MG status of an active BWP in at least one of multiple CCs which are aggregated is active, in the case that the first pre-MG is a pre-UE gap; and determine to deactivate the first pre-MG if pre-MG statuses of active BWPs in all the multiple CCs which are aggregated are inactive, in the case that the first pre-MG is the pre-UE gap. The A/D unit 302 is configured to determine to activate the first pre-MG if a pre-MG status of an active BWP in at least one of multiple CCs in an FR same as an FR where the first pre-MG is located is active, in the case that the first pre-MG is a pre-FR gap; and determine to deactivate the first pre-MG if pre-MG statuses of active BWPs in all the multiple CCs in the FR same as the FR where the first pre-MG is located are inactive, in the case that the first pre-MG is the pre-FR gap.

In some optional embodiments, the A/D unit 302 is configured to determine to deactivate a second pre-MG in the case that the RRC configuration indicates that a status of the second pre-MG is inactive.

In some optional embodiments, the RRC signaling carries second indication information, where the second indication information indicates at least one set of information, each of the at least one set of information contains a BWP identifier (ID) and a flag corresponding to the BWP ID, and a value of the flag includes at least one of: a first value, a second value, or a third value. The value of the flag being the first value indicates that an MG configuration associated with a BWP indicated by the BWP ID is in a deactivation status. The value of the flag being the second value indicates that the MG configuration associated with the BWP indicated by the BWP ID is in an activation status, or indicates that the BWP indicated by the BWP ID is in the deactivation status and the MG configuration associated with the BWP is in the activation status. The value of the flag being the third value indicates that the BWP indicated by the BWP ID is in the activation status and the MG configuration associated with the BWP is in the activation status.

In some optional embodiments, the A/D unit 302 is configured to perform the following in the case that the UE capability indicates that the terminal device supports the first manner or supports the first manner and the third manner. The A/D unit 302 is configured to determine to activate the pre-MG if a value of at least one flag in the at least one set of information is the second value or the third value. The A/D unit 302 is configured to determine to deactivate the pre-MG if values of all flags in the at least one set of information each are the first value.

In some optional embodiments, the A/D unit 302 is further configured to determine that a pre-MG status of a BWP on an SCell is inactive if the SCell is in a deactivation status.

In some optional embodiments, for the third manner, the rule includes at least one of a first rule or a second rule. The first rule is to automatically activate or deactivate the pre-MG according to a trigger event, where the trigger event includes at least one of: BWP switching, adding an MO, removing an MO, adding a PSCell, releasing a PSCell, changing a PSCell, adding an SCell, releasing an SCell, changing an SCell, activating an SCell, deactivate an SCell, or a dedicated measurement requirement. The second rule is to deactivate the pre-MG if an MG is not required by any of configured MOs; or activate the pre-MG if an MG is required by any one of the configured MOs.

In some optional embodiments, in the case that the trigger event is BWP switching, the first rule specifically includes: activating the pre-MG if a band width (BW) of an RS for a configured MO is not fully within an active BWP; or deactivating the pre-MG if the BW of the RS for the configured MO is fully within the active BWP.

In some optional embodiments, the specific scenario includes at least one of: a first scenario, a second scenario, or a third scenario. The first scenario is a scenario in which a single active BWP is on a single carrier. The second scenario is a scenario in which BWP switching is performed on CCs which are aggregated. The third scenario is a scenario in which multiple active BWPs are on multiple CCs.

In some optional embodiments, the specific manner is a BWP switching-based autonomous pre-MG A/D manner and is applied in at least one of the first scenario, the second scenario, or the third scenario.

In some optional embodiments, for CSI-RS-based L3 measurement or PRS-based measurement, a default status of the pre-MG is active; and for SSB-based L3 measurement, the default status of the pre-MG is configurable.

Those of skill in the art may understand that, related illustration of the apparatus for MG enhancement above in embodiments of the disclosure may refer to the related illustration of the method for MG enhancement above in embodiments of the disclosure.

FIG. 4 is a schematic structural diagram of a communication device 400 provided in embodiments of the disclosure. The communication device may be applied for a terminal device. The communication device 400 illustrated in FIG. 4 includes a processor 410. The processor 410 may be configured to invoke and run computer programs from a memory to implement the method in embodiments of the disclosure.

Optionally, as illustrated in FIG. 4, the communication device 400 may further include a memory 420. The processor 410 may be configured to invoke and run computer programs from the memory 420 to implement the method in embodiments of the disclosure.

The memory 420 may be a separate device independent of the processor 410, or may be integrated into the processor 410.

Optionally, as illustrated in FIG. 4, the communication device 400 may further include a transceiver 430. The processor 410 can control the transceiver 430 to communicate with other devices. Specifically, the transceiver 430 can transmit information or data to other devices, or receive information or data transmitted by other devices.

The transceiver 430 may include a transmitter and a receiver. The transceiver 430 may further include one or more antennas.

The communication device 400 may be the terminal device in the embodiments of the disclosure, and the communication device 400 can implement the corresponding process implemented by the terminal device in each of the methods of the embodiments of the disclosure, which will not be repeated herein for the sake of simplicity.

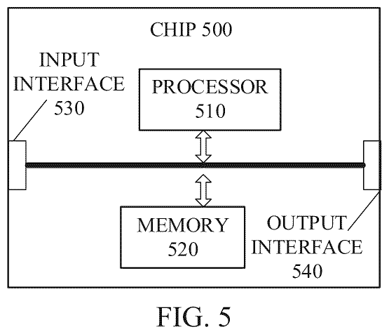

FIG. 5 is a schematic structural diagram of a chip in embodiments of the disclosure. The chip 500 illustrated in FIG. 5 includes a processor 510. The processor 510 is configured to invoke and run computer programs from a memory to implement the method in embodiments of the disclosure.

Optionally, as illustrated in FIG. 5, the chip 500 may further include a memory 520. The processor 510 is configured to invoke and run computer programs from the memory 520 to implement the method in embodiments of the disclosure.

The memory 520 may be a separated device independent of the processor 510, or may be integrated into the processor 510.

Optionally, the chip 500 may further include an input interface 530. The processor 510 can control the input interface 530 to communicate with other devices or chips. Specifically, the input interface 530 can obtain information or data transmitted by other devices or chips.

Optionally, the chip 500 may further include an output interface 540. The processor 510 can control the output interface 540 to communicate with other devices or chips. Specifically, the output interface 540 can output information or data to other devices or chips.

The chip may be applied for the terminal device in embodiments of the disclosure, and the chip can implement the corresponding process implemented by the terminal device in each of the methods in the embodiments of the disclosure, which will not be repeated herein for the sake of simplicity.

It can be understood that, the chip mentioned in the embodiments of the disclosure may also be referred to as a system-level chip, a system chip, a chip system, a system-on-a-chip chip, or the like.

It may be understood that, the processor in embodiments of the disclosure may be an integrated circuit chip with signal processing capabilities. During implementation, each step of the foregoing method may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments can be implemented or executed. The general purpose processor may be a microprocessor, or the processor may be any conventional processor or the like. The steps of the method disclosed in embodiments may be directly implemented as a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the above-mentioned method with the hardware thereof.

It can be understood that, the memory may be a volatile memory or a non-volatile memory, or may include both the volatile memory and the non-volatile memory. The non-volatile memory may be a ROM, a PROM, an erasable PROM (EPROM), an electrically EPROM (EEPROM), or a flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memory of the system and the method described herein is intended to include, but is not limited to, these and any other suitable types of memory.

It may be understood that, the above description of the memory is intended for illustration rather than limitation. For example, the memory of embodiments may also be an SRAM, a DRAM, an SDRAM, a DDR SDRAM, an ESDRAM, an SLDRAM, a DR RAM, and so on. In other words, the memory of embodiments is intended to include, but is not limited to, these and any other suitable types of memory.

A computer-readable storage medium is further provided in embodiments of the disclosure. The computer readable storage medium is configured to store computer programs. The computer readable storage medium is applicable to the terminal device of embodiments. The computer programs are operable with a computer to implement the operations performed by the terminal device described in the foregoing method embodiments, which will not be repeated herein for the sake of simplicity.

A computer program product is further provided in embodiments of the disclosure. The computer program product includes computer program instructions. The computer program product is applicable to the terminal device of embodiments. The computer program instructions are operable with a computer to implement the operations performed by the terminal device described in the foregoing method embodiments, which will not be repeated herein for the sake of simplicity.

A computer program is further provided in embodiments of the disclosure. The computer program is applicable to the terminal device of embodiments. The computer program is operable with a computer to implement the operations performed by the terminal device described in the foregoing method embodiments, which will not be repeated herein for the sake of simplicity.

Those of ordinary skill in the art will appreciate that units and algorithmic operations of various examples described in connection with embodiments herein can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods may not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method embodiments, which will not be repeated herein.

It will be appreciated that the systems, apparatuses, and methods disclosed in embodiments herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

In addition, various functional units described in embodiments herein may be integrated into one processing unit or may be present as a number of physically separated units, and two or more units may be integrated into one.

If the functions are implemented as software functional units and sold or used as standalone products, they may be stored in a computer readable storage medium. Based on such an understanding, the essential technical solution, or the portion that contributes to the prior art, or all or part of the technical solution of the disclosure may be embodied as software products. The computer software products can be stored in a storage medium and may include multiple instructions that, when executed, can cause a computing device, e.g., a personal computer, a server, a network device, etc., or a processor to execute some or all operations of the methods described in various embodiments. The above storage medium may include various kinds of media that can store program codes, such as a universal serial bus (USB) flash disk, a mobile hard drive, an ROM, an RAM, a magnetic disk, or an optical disk.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure may be stated in the scope of protection of the claims.

What is claimed is:

1. A method for measurement gap (MG) enhancement, comprising:
determining, by a terminal device, a user equipment (UE) capability of the terminal device, the UE capability indicating whether the terminal device supports a pre-configured MG (pre-MG) activation/deactivation (A/D) capability in a specific manner and/or a specific scenario; and
determining, by the terminal device according to the UE capability, whether to activate or deactivate a pre-MG.

2. The method of claim 1, wherein the specific manner comprises at least one of:
a first manner, wherein the first manner is a radio resource control (RRC) signaling-based pre-MG A/D manner;
a second manner, wherein the second manner is a medium access control (MAC) control element (CE)-based pre-MG A/D manner; or
a third manner, wherein the third manner is a rule-based autonomous pre-MG A/D manner.

3. The method of claim 2, wherein determining, by the terminal device according to the UE capability, whether to activate or deactivate the pre-MG comprises:
in the case that the UE capability indicates that the terminal device supports the third manner and does not support the first manner,
determining, by the terminal device, to activate the pre-MG in response to a pre-MG status of an active band width part (BWP) in at least one of a plurality of component carriers (CCs) being active; and
determining, by the terminal device, to deactivate the pre-MG in response to pre-MG statuses of active BWPs in all the plurality of CCs being inactive.

4. The method of claim 3, wherein determining, by the terminal device, to activate the pre-MG in response to the pre-MG status of the active BWP in at least one of the plurality of CCs being active; and determining, by the terminal device, to deactivate the pre-MG in response to the pre-MG statuses of the active BWPs in all the plurality of CCs being inactive, comprise:
in the case that the pre-MG is a per-UE MG (pre-UE gap), determining, by the terminal device, to activate the pre-MG in response to a pre-MG status of an active BWP in at least one of a plurality of carriers which are aggregated being active; and determining, by the terminal device, to deactivate the pre-MG in response to pre-MG statuses of active BWPs in all the plurality of carriers being inactive; and
in the case that the pre-MG is a per-frequency range (FR) MG (pre-FR gap), determining, by the terminal device, to activate the pre-MG in response to a pre-MG status of an active BWP in at least one of a plurality of CCs in an FR same as an FR where the pre-MG is located being active; and determining, by the terminal device, to deactivate the pre-MG in response to pre-MG statuses of active BWPs in all the plurality of CCs in the FR same as the FR where the pre-MG is located being inactive.

5. The method of claim 3, wherein determining, by the terminal device, to activate the pre-MG in response to the pre-MG status of the active BWP in at least one of the plurality of CCs being active; and determining, by the terminal device, to deactivate the pre-MG in response to the pre-MG statuses of the active BWPs in all the plurality of CCs being inactive, comprise:
in the case that the pre-MG is a CC group gap, determining, by the terminal device, to activate the pre-MG in response to a pre-MG status of an active BWP in at least one of a plurality of CCs in a CC group same as a CC group where the pre-MG is located being active; and determining, by the terminal device, to deactivate the pre-MG in response to pre-MG statuses of active BWPs in all the plurality of CCs in the CC group same as the CC group where the pre-MG is located being inactive.

6. The method of claim 2, wherein the RRC signaling carries a BWP configuration, wherein the BWP configuration comprises first indication information, and the first indication information indicates an A/D status of a pre-MG associated with a BWP.

7. The method of claim 6, wherein determining, by the terminal device according to the UE capability, whether to activate or deactivate the pre-MG comprises:
in the case that the UE capability indicates that the terminal device supports the first manner or supports the first manner and the third manner,
in the case that the pre-MG is a pre-UE gap, determining, by the terminal device, to activate the pre-MG in response to a pre-MG status of an active BWP in at least one of a plurality of CCs which are aggregated being active; and determining, by the terminal device, to deactivate the pre-MG in response to pre-MG statuses of active BWPs in all the plurality of CCs which are aggregated being inactive; and
in the case that the pre-MG is a pre-FR gap, determining, by the terminal device, to activate the pre-MG in response to a pre-MG status of an active BWP in at least one of a plurality of CCs in an FR same as an FR where the pre-MG is located being active; and determining, by the terminal device, to deactivate the pre-MG in response to pre-MG statuses of active BWPs in all the plurality of CCs in the FR same as the FR where the pre-MG is located being inactive.

8. The method of claim 2, wherein the RRC signaling carries:
a BWP configuration, wherein the BWP configuration comprises first indication information, and the first indication information indicates an A/D status of a pre-MG associated with a BWP; and
an RRC configuration, wherein the RRC configuration indicates an A/D status of each of at least one pre-MG.

9. The method of claim 8, wherein determining, by the terminal device according to the UE capability, whether to activate or deactivate the pre-MG comprises:
in the case that the UE capability indicates that the terminal device supports the first manner or supports the first manner and the third manner, and the RRC configuration indicates that a status of a first pre-MG is active,
in the case that the first pre-MG is a pre-UE gap, determining, by the terminal device, to activate the first pre-MG in response to a pre-MG status of an active BWP in at least one of a plurality of CCs which are aggregated being active; and determining, by the terminal device, to deactivate the first pre-MG in response to pre-MG statuses of active BWPs in all the plurality of CCs which are aggregated being inactive; and
in the case that the first pre-MG is a pre-FR gap, determining, by the terminal device, to activate the first pre-MG in response to a pre-MG status of an active BWP in at least one of a plurality of CCs in an FR same as an FR where the first pre-MG is located being active; and determining, by the terminal device, to deactivate the first pre-MG in response to pre-MG statuses of active BWPs in all the plurality of CCs in the FR same as the FR where the first pre-MG is located being inactive.

10. The method of claim 8, wherein determining, by the terminal device according to the UE capability, whether to activate or deactivate the pre-MG comprises:
determining, by the terminal device, to deactivate a second pre-MG in the case that the RRC configuration indicates that a status of the second pre-MG is inactive.

11. The method of claim 2, wherein for the third manner, the rule-based autonomous pre-MG A/D manner comprises at least one of:
a first rule, wherein the first rule is to automatically activate or deactivate the pre-MG according to a trigger event, wherein the trigger event comprises at least one of: BWP switching, adding a measurement object (MO), removing an MO, adding a primary secondary cell (PSCell), releasing a PSCell, changing a PSCell, adding an SCell, releasing an SCell, changing an SCell, activating an SCell, deactivate an SCell, or a dedicated measurement requirement; or
a second rule, wherein the second rule is to deactivate the pre-MG in response to an MG being not required by any of configured MOs; or activate the pre-MG in response to an MG being required by any one of the configured MOs.

12. The method of claim 11, wherein the trigger event is BWP switching, and the first rule comprises:
activating the pre-MG in response to a band width (BW) of a reference signal (RS) for a configured MO being not fully within an active BWP; or deactivating the pre-MG in response to the BW of the RS for the configured MO being fully within the active BWP.

13. The method of claim 1, wherein:
for channel state information-reference signal (CSI-RS)-based layer 3 (L3) measurement or PRS-based measurement, a default status of the pre-MG is active; and
for SSB-based L3 measurement, the default status of the pre-MG is configurable.

14. A terminal device, comprising:
a processor and a memory, the memory being configured to store computer programs, which when executed by the processor, causes the processor to:
determine a user equipment (UE) capability of the terminal device, the UE capability indicating whether the terminal device supports a pre-configured MG (pre-MG) activation/deactivation (A/D) capability in a specific manner and/or a specific scenario; and
determine according to the UE capability whether to activate or deactivate a pre-MG.

15. The terminal device of claim 14, wherein the specific manner comprises at least one of:
a first manner, wherein the first manner is a radio resource control (RRC) signaling-based pre-MG A/D manner;
a second manner, wherein the second manner is a medium access control (MAC) control element (CE)-based pre-MG A/D manner; or
a third manner, wherein the third manner is a rule-based autonomous pre-MG A/D manner.

16. The terminal device of claim 15, wherein for the third manner, the rule-based autonomous pre-MG A/D manner comprises at least one of:
a first rule, wherein the first rule is to automatically activate or deactivate the pre-MG according to a trigger event, wherein the trigger event comprises at least one of: BWP switching, adding a measurement object (MO), removing an MO, adding a primary secondary cell (PSCell), releasing a PSCell, changing a PSCell, adding an SCell, releasing an SCell, changing an SCell, activating an SCell, deactivate an SCell, or a dedicated measurement requirement; or
a second rule, wherein the second rule is to deactivate the pre-MG in response to an MG being not required by any of configured MOs; or activate the pre-MG in response to an MG being required by any one of the configured MOs.

17. The terminal device of claim 16, wherein the trigger event is BWP switching, and the first rule comprises:
activating the pre-MG in response to a band width (BW) of a reference signal (RS) for a configured MO being not fully within an active BWP; or deactivating the pre-MG in response to the BW of the RS for the configured MO being fully within the active BWP.

18. A non-transitory computer-readable storage medium configured to store computer programs, which when executed by a computer, causes the computer to:
determine a user equipment (UE) capability of the terminal device, the UE capability indicating whether the terminal device supports a pre-configured MG (pre-MG) activation/deactivation (A/D) capability in a specific manner and/or a specific scenario; and
determine according to the UE capability whether to activate or deactivate a pre-MG.

19. The non-transitory computer-readable storage medium of claim 18, wherein the specific scenario comprises at least one of:
a first scenario, wherein the first scenario is a scenario in which a single active BWP is on a single CC;
a second scenario, wherein the second scenario is a scenario in which BWP switching is performed on CCs which are aggregated; or
a third scenario, wherein the third scenario is a scenario in which a plurality of active BWPs are on a plurality of CCs.

20. The non-transitory computer-readable storage medium of claim 19, wherein the specific manner is a BWP switching-based autonomous pre-MG A/D manner and is applied in at least one of the first scenario, the second scenario, or the third scenario.
